(19) United States
(12) Patent Application Publication
(10) Pub. No.: US 2013/0112037 A1
(43) Pub. Date: May 9, 2013

(54) FLYING DEVICE BASED ON BIASED CENTRIFUGAL FORCE

(71) Applicant: Minoru Oyama, San Diego, CA (US)

(72) Inventor: Minoru Oyama, San Diego, CA (US)

(21) Appl. No.: 13/289,698

(22) Filed: Nov. 4, 2011

(51) Int. Cl. F03G 3/08

(52) U.S. Cl. 74/572.1

(57) ABSTRACT

A flying device is provided, including a disk configured to rotate around its axis, a ring in parallel with the disk, multiple loads coupled to the disk and the ring, multiple first pivots circularly arranged in the peripheral region of the disk and respectively coupled to the multiple loads, and multiple second pivots circularly arranged in the ring and respectively coupled to the multiple loads. The ring is positioned in parallel with the disk with a shift relative to the disk to follow the rotation of the disk through the loads, while keeping the position with respect to the disk. The rotation of the disk generates a centrifugal force biased in the direction of the shift, providing a force to move toward a direction determined by the shift.

### BACKGROUND

The flying mechanism of an aircraft, a helicopter and other existing flying vehicles relies on a force component called “lift” that can be generated by moving in a fluid such as air. Thus, it is inherently difficult to maneuver such a vehicle in air turbulence. For example, it is difficult to use a helicopter for rescuing people trapped on the roof of a burning building. This is because the conditions in the vicinity of a burning building are not favorable to helicopter landing or hovering due to the updraft created by the fire. The updraft adversely affects the ability of the pilots to maneuver. It is well known among those skilled in the art that due to the severe updraft helicopters could not be deployed to rescue people in the World Trade Center during the 9/11 terrorism. In another example, it is difficult to fly a helicopter in mountainous environments especially under bad weather conditions. This is because the wind flows over and around the terrain in an inconsistent and unpredictable matter, often generating turbulence to make hazardous flying conditions. The pilot may encounter a loss of lift in turbulent winds. A severe turbulence may be generated by the onset of gusty winds from a nearby thunder cell. Many accidents in mountainous areas have been reported to date. Another example of an existing flying vehicle is a rocket, which requires a special fuel such as liquid hydrogen to produce strong propellants, and hence a special launching site.

### BRIEF DESCRIPTION OF THE DRAWINGS

FIG. 1 is a perspective view illustrating the device according to an embodiment.

FIG. 2 is a perspective view illustrating the first section and the second section of the device separately.

FIG. 3 is a front plan view with respect to the vertical plane, illustrating the disk, the plurality of loads and the ring of the device separately.

FIG. 4A shows a two-dimensional illustration of the positioning of the ring with respect to the disk for biasing the centrifugal force upward (in the vertical direction F_{V}).

FIG. 4B shows a two-dimensional illustration of the positioning of the ring with respect to the disk for biasing the centrifugal force in the direction toward right by a predetermined acute angle away from the vertical direction, as indicated by an arrow F_{R}.

FIG. 4C shows a two-dimensional illustration of the positioning of the ring with respect to the disk for biasing the centrifugal force in the direction toward left by a predetermined acute angle away from the vertical direction, as indicated by an arrow F_{L}.

FIG. 5A illustrates a configuration of the two rings for moving the vehicle in one direction in the vertical plane, wherein a driver may be situated so that this direction is a forward direction for the driver.

FIG. 5B illustrates a configuration of the two rings for moving the vehicle in another direction in the vertical plane, wherein a driver may be situated so that this direction is a backward direction for the driver.

FIG. 5C illustrates a configuration of the two rings for turning the vehicle to the left.

FIG. 5D illustrates a configuration of the two rings for turning the vehicle to the right.

### DETAILED DESCRIPTION

In view of the problems inherently associated with the fundamental flying mechanism based on lift or thrust, the present document discloses a flying device that does not rely on the presence of air or propellants. The flying mechanism of the present flying device involves centrifugal force that is biased in a particular direction.

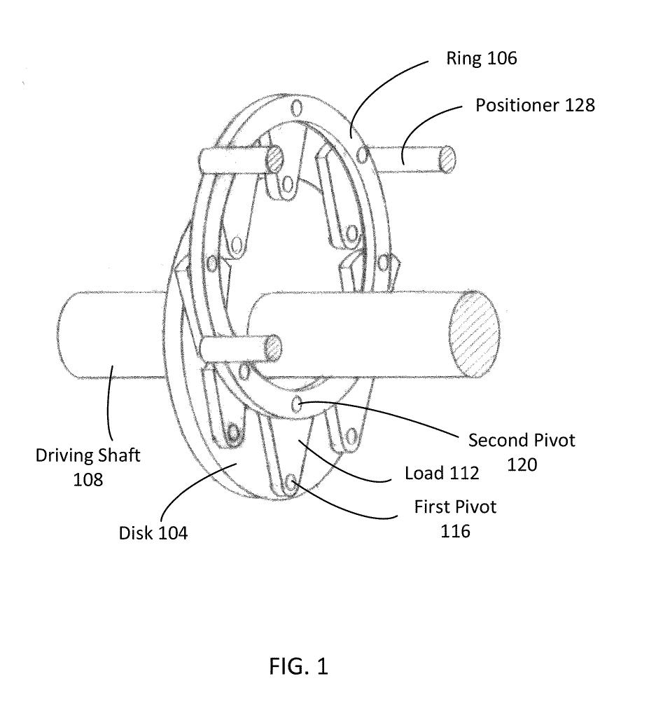

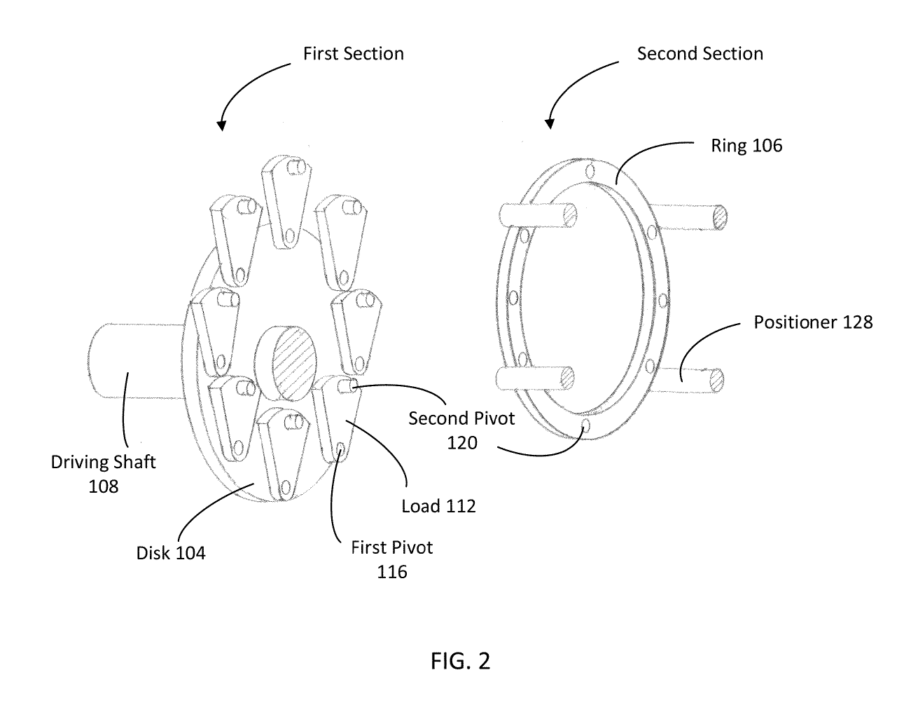

The structure of the flying device based on biased centrifugal force according to an embodiment is explained below with reference to FIGS. 1 and 2. FIG. 1 is a perspective view illustrating the device. The device comprises a first section and a second section coupled to each other, the first section including a disk 104 and a second section including a ring 106. FIG. 2 is a perspective view illustrating the first section and the second section of the device separately. The disk 104 is configured to have a circular plane along the vertical plane with a predetermined thickness along the horizontal axis. A driving shaft 108 is configured to have a cylindrical shape penetrating through the center of the disk 104, and the driving shaft 108 and the disk 104 are attached at the center of the disk 104. The driving shaft 108 is elongated along the horizontal axis, perpendicular to the disk 104. Alternatively, one end of the driving shaft 108 may be configured to attach to the center of the disk 104 to position the driving shaft 108 perpendicular to the disk, instead of having the driving shaft penetrated through the center of the disk 104. Although omitted from the figure, the driving shaft 108 is coupled to an power source such as a battery, an engine, a solar cell and the like that provides torque for the rotational movement around the axis of the driving shaft 108. The driving shaft 108 is perpendicularly attached to the disk 104 at the center; thus, the disk 104 and the driving shaft 108 together rotate around the horizontal axis while being driven. Alternatively, the disk 104 may be configured to rotate around the axis remotely, electromagnetically or by other driving means without the driving shaft 108. A plurality of loads 112 are coupled to the peripheral region of one side of the disk 104 through a plurality of first pivots 116, respectively. Each of the first pivots 116 has two end portions. One end portion of a first pivot 116 is attached to a location in the peripheral region of the disk 104. The other end portion of the first pivot 116 is rotatably attached to a location of a load 112, so that the plurality of loads 112 can rotate around the plurality of first pivots 116, respectively.

The ring 106 is configured to have a region of a circular plane bound by two concentric radii along the vertical plane with a predetermined thickness along the horizontal axis. The plurality of loads 112 are coupled to the ring 106 through a plurality of second pivots 120, respectively. Each of the second pivots 120 has two end portions. One end portion of a second pivot 120 is attached to a location in the ring 106. The other end portion of the second pivot 120 is rotatably attached to a location of a load 112, so that the plurality of loads 112 can rotate around the plurality of second pivots 120, respectively. The distance between the first location of a load 112 where the first pivot 116 is rotatably attached and the second location of the same load 112 where the second pivot 120 is rotatably attached is predetermined, and fixed to be substantially the same for all the loads 112. The plurality of second pivots 120 are attached to the ring 106 with a spacing corresponding to the spacing of the plurality of first pivots 116. The total numbers of the loads 112, the first pivots 116 and the second pivots 120 are the same. These pivots may be attached to the disk 104 or to the ring 106 by using an adhesive, nails, screws or other fastening means or by welding. Alternatively, the disk 104 or the ring 106 may include openings that are configured to firmly hold and attach to the respective pivots. The first pivots 116, the loads 112 and the second pivots 116 can be configured so that it is possible to adjust the distance between the first location and the second location of the load 112. Furthermore, one or more positioners 128 are coupled to the ring 106 for positioning the ring 106 with respect to and in parallel with the disk 104. The number of the positioners is 4 in the present example; however, the number of the positioners can be one or more, and the positioning means can be of any techniques known to those skilled in the art. The positioners 128 can be coupled to the inner or the outer peripheral of the ring 106, as long as the ring 106 is properly positioned. Alternatively, the relative position of the ring 106 may be controlled electromagnetically, remotely or by using other positioning means instead of using mechanical means such as solid rods as illustrated in the figures.

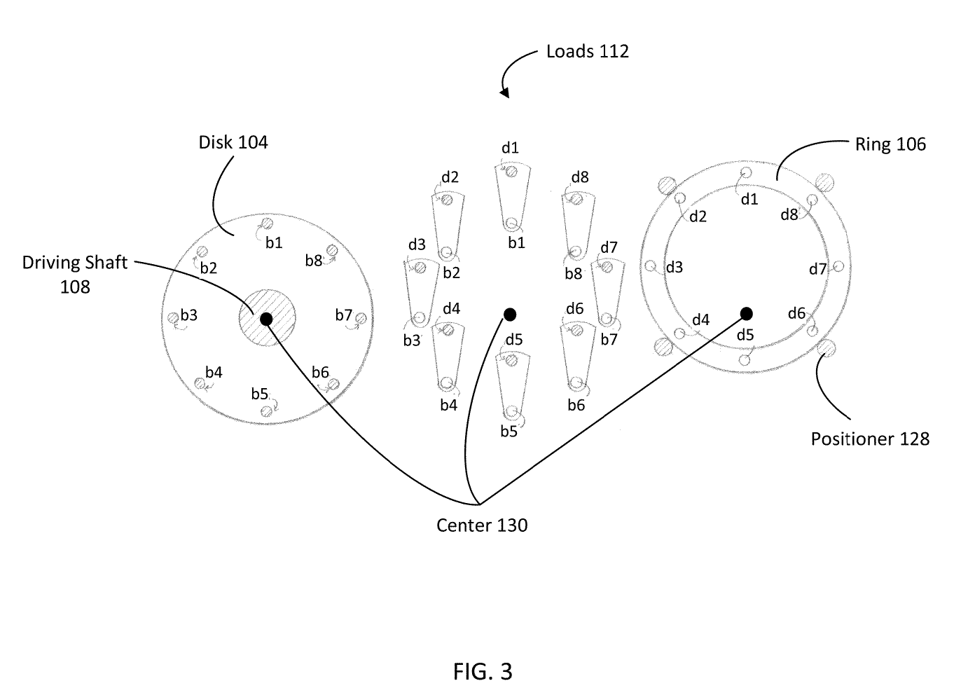

The movements of the disk 104, the plurality of loads 112 and the ring 106 are explained with reference to FIG. 3, which is a front plan view with respect to the vertical plane, illustrating the disk 104, the plurality of loads 112 and the ring 106 separately. In this example, the plurality of first pivots 116 are labeled b1, b2 . . . and b8, and the plurality of second pivots 120 are labeled d1, d2 . . . and d8. Each of the plurality of loads 112 is rotatably attached to one of the first pivots 116, i.e., b1, b2 . . . and b8 at one location, and is also rotatably attached to one of the second pivots 120, i.e., d1, d2 . . . and d8 at another location. The pairs of the first and second pivots, i.e., b1-d1, b2-d2 . . . and b8-d8, are coupled to respective loads 112. The numbers of the first pivots, the second pivots and the loads are 8 in this example; however, the number can be any plural numbers. By using the one or more positioners 128, the relative position of the ring 106 can be adjusted with respect to and in parallel with the disk 104, in other words, with respect to the center 130 of the disk 104 in the plan view of FIG. 3. As the driving shaft 108 is driven to rotate around its axis, the first pivots 116, i.e., b1, b2 . . . and b8, revolve around the center 130 with the disk 104. The ring 106 follows the rotational movement of the disk 104 through the loads 112, while keeping the relative position with respect to the disk 104. The ring 106 merely follows the rotational movement of the disk 104 without consuming substantial energy except for the friction with the second pivots 120, i.e. d1, d2 . . . and d8. The relative position between the disk 104 and the ring 106, which are kept in parallel, is determined essentially by the difference in position between the circularly arranged first pivots 116, b1, b2 . . . and b8 and the circularly arranged second pivots 120, d1, d2 . . . and d8, which is, in turn, determined by the distance between the locations of the first pivot and the second pivot attached to the load 112. The first pivots 116, b1, b2 . . . and b8 follow the revolution of the disk 104, and the second pivots 120, d1, d2 . . . and d8 follow the revolution of the ring 106. The ring 106 follows the rotation of the disk 104 through the loads 112. Therefore, the orientation of all the loads 112 remains substantially the same since each of the loads 112 pivots around the first pivot 116 and the second pivot 120 simultaneously, while keeping the relative position substantially the same between the disk 104 and the ring 106 (in other words, between the circularly arranged first pivots 116, b1, b2 . . . and b8 and the circularly arranged second pivots 120, d1, d2 . . . and d8). In the example of FIGS. 1-3, the position of the ring 106 is vertically shifted with respect to and in parallel with the disk 104; thus, all the loads 112 are aligned vertically during the rotation.

In general, an object moving in a circle behaves as if it is experiencing an outward force. This force is known as the centrifugal force, which increases with the radius of the circle. In the device as illustrated in FIGS. 1-3, if the second section, which includes the ring 106, and the second pivots 120 are removed, all the loads 112 will point in an outward direction when the disk 104 rotates around the axis. This is due to the centrifugal force. However, in the present example shown in FIGS. 1-3, the centrifugal force is biased vertically by means of the ring 106 that follows the rotational movement of the disk 104 while keeping the relative position with respect to the disk 104. Therefore, all the loads 112 in the device of FIGS. 1-3 will point in an upward direction due to the vertically biased centrifugal force when the disk 104 rotates around the axis. As a result, the device will experience the lift-up force, thereby capable of moving vertically when the lift-up force wins over the gravity.

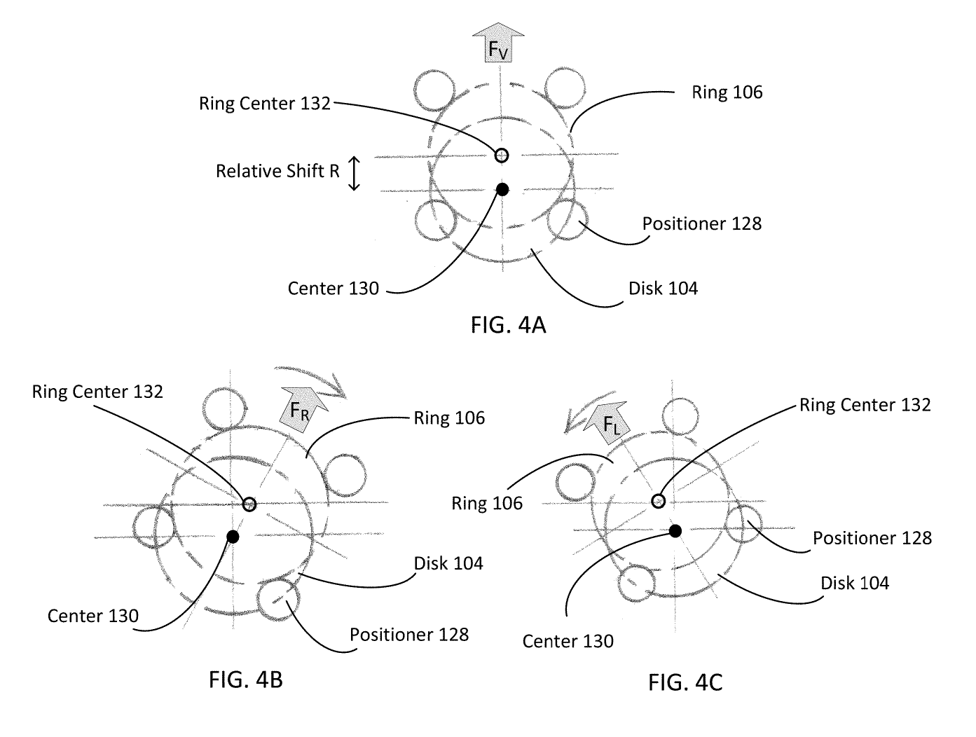

FIG. 4A shows a two-dimensional illustration of the positioning of the ring 106 with respect to the disk 104 for biasing the centrifugal force upward (i.e., in the vertical direction indicated by an arrow F_{V}). In this 2D illustration, the relative position between the disk 104 and the ring 106 is indicated by the relative shift R of a ring center 132 of the ring 106 with respect to the center 130 of the disk 104. The disk 104 and the ring 106 are kept in parallel to each other. The positioning of the ring 106 is adjusted by using the one or more positioners 128, remotely, electromagnetically or through other positioning means. Any positioning techniques known to those skilled in the art can be applied. As illustrated in FIGS. 1-3, in this case of vertically biased centrifugal force, all the loads 112 are aligned vertically as the disk 104 rotates around the axis. Control of the movement of the device toward right and left in the vertical plane is illustrated in FIGS. 4B and 4C, respectively. FIG. 4B shows a two-dimensional illustration of the positioning of the ring 106 with respect to the disk 104 for biasing the centrifugal force in the direction toward right by a predetermined acute angle away from the vertical direction, as indicated by an arrow F_{R}. The ring 106 is rotated clockwise by the acute angle; thus, the relative shift R is in the direction of the F_{R}. In this case, all the loads 112 are aligned in the direction of F_{R}. FIG. 4C shows a two-dimensional illustration of the positioning of the ring 106 with respect to the disk 104 for biasing the centrifugal force in the direction toward left by a predetermined acute angle away from the vertical direction, as indicated by an arrow F_{L}. The ring 106 is rotated counter-clockwise by the acute angle; thus, the relative shift R is in the direction of the F_{L}. In this case, all the loads 112 are aligned in the direction of F_{L}.

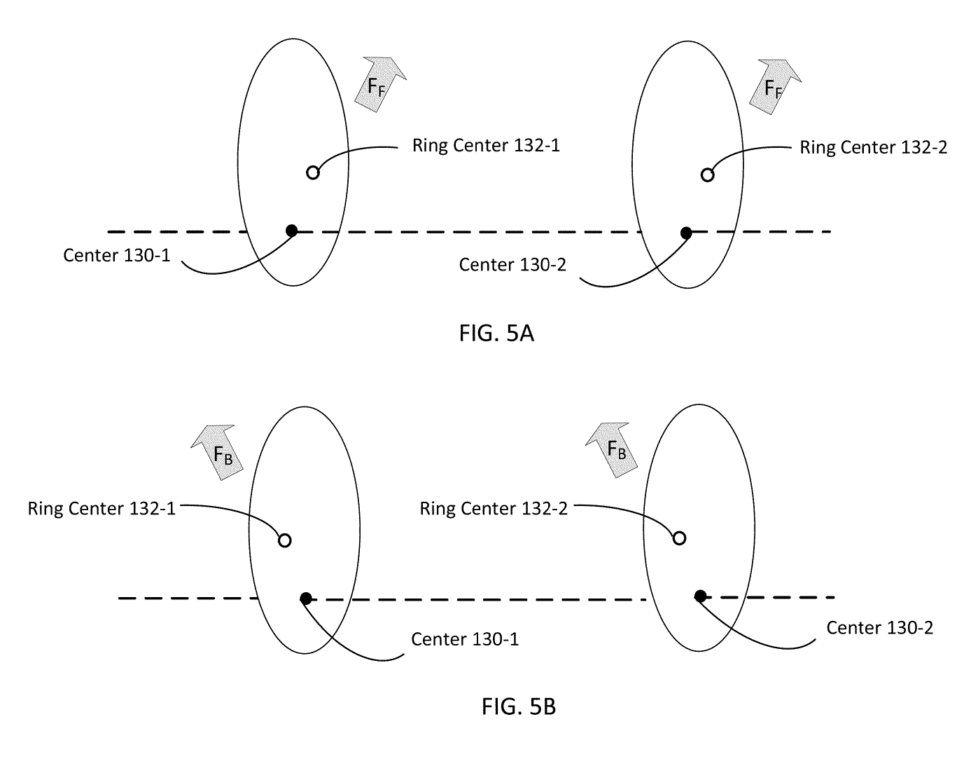

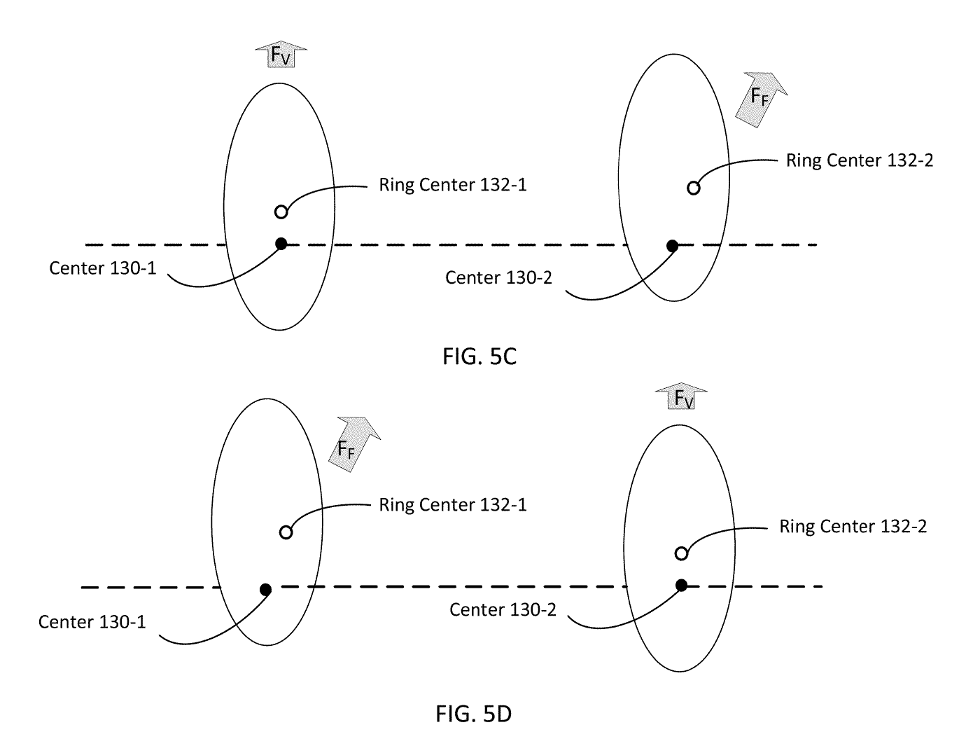

Two or more flying devices can be used to drive a vehicle. Examples of steering the vehicle equipped with two flying devices are illustrated in FIGS. 5A-5D. The first flying device includes a first disk with a center 130-1 coupled with a first ring with a ring center 132-1; the second flying device includes a second disk with a center 130-2 coupled with a second ring with a ring center 132-2. The first disk and the first ring of the first device and the second disk and the second ring of the second device are placed in the direction along the vertical plane and in parallel to each other in this example. FIG. 5A illustrates a configuration of the two rings for moving the vehicle in one direction in the vertical plane. A driver may be situated so that this direction is a forward direction for the driver. Both the ring centers 132-1 and 132-2 are positioned with the shift in the direction of F_{F} with respect to the disk centers 130-1 and 130-2, respectively. As a result, the vehicle experiences the centrifugal force biased toward the direction of F_{F}. FIG. 5B illustrates a configuration of the two rings for moving the vehicle in another direction in the vertical plane. A driver may be situated so that this direction is a backward direction for the driver. Both the ring centers 132-1 and 132-2 are positioned with the shift in the direction of F_{B} with respect to the disk centers 130-1 and 130-2, respectively. Therefore, the vehicle experiences the centrifugal force biased toward the direction of F_{B}. FIG. 5C illustrates a configuration of the two rings for turning the vehicle to the left. The ring center 132-1 is positioned with the shift in the vertical direction Fv with respect to the disk center 130-1. On the other hand, the ring center 132-2 is positioned with the shift in the direction F_{F} with respect to the disk center 130-2. As a result, the vehicle experiences the force to turn left, while being lifted by the vertical force. FIG. 5D illustrates a configuration of the two rings for turning the vehicle to the right. The ring center 132-2 is positioned with the shift in the vertical direction F_{V} with respect to the disk center 130-2. On the other hand, the ring center 132-1 is positioned with the shift in the direction F_{F} with respect to the disk center 130-1. As a result, the vehicle experiences the force to turn right, while being lifted by the vertical force.

An example of a flying vehicle equipped with two flying devices is described above. However, the vehicle may be equipped with three, four or more flying devices for more power and steering flexibility. In FIGS. 5A-5D, the centers of the two disks are coupled as indicated by dashed line, analogous to a front-wheel driving. However, the disks in the present flying vehicle may be independently driven.

In general, the flying mechanism of an aircraft, a helicopter and other existing flying vehicles can be explained in terms of a force component called “lift.” Air flowing past the surface of a body exerts a surface force on it. Lift is a component of this force that is perpendicular to the oncoming flow direction. Effective generation of lift is commonly associated with the use of a wing of an aircraft or propellers of a helicopter. These wings or propellers are designed such that curved stream lines of air are generated above and below resulting in an overall downward reflection of the air. In the case of an aircraft wing, the wing exerts a downward force on the air, while the air exerts an upward force on the wing according to the second and third of the Newton's laws of motion. Therefore, the existing flying vehicles rely on lift that can be generated by moving in a fluid such as air.

In contrast to such existing flying mechanisms, the present device shown in FIGS. 1-3 relies on the biased centrifugal force, which does not require the presence of air or any fluid. Therefore, flying in outer space is possible using the present device. A vehicle provided with the present device can be configured to carry a driver, peripheral systems and materials, and the like. One such peripheral system may include a battery, an engine, a solar cell or other power source to drive the rotation. The flying device can be provided in the vehicle or outside the vehicle. Such a vehicle can be further configured to have a cover to encase air, a driver, peripheral systems and materials, for example, for outer space traveling. The vehicle can lift up from the site without a special launching site. The vehicle equipped with the present flying device may be especially useful in situations wherein it is difficult to maneuver an aircraft or a helicopter. For example, it is difficult to use a helicopter for rescuing people trapped on the roof of a burning building. This is because the conditions in the vicinity of a burning building are not favorable to helicopter landing or hovering due to the updraft created by the fire. The updraft adversely affects the ability of the pilots to maneuver. The vehicle provided with the present device can hover smoothly since it does not require the presence of air, and come close to a target site of the burning building by contacting and sliding its body on the building wall. In another example, it is difficult to fly a helicopter in mountainous environments especially under bad weather conditions. This is because the wind flows over and around the terrain in an inconsistent and unpredictable matter, often generating turbulence to make hazardous flying conditions. The pilot may encounter a loss of lift in turbulent winds. A severe turbulence may be generated by the onset of gusty winds from a nearby thunder cell. Here, again, the vehicle provided with the present device can move stably in mountainous areas since it does not require the presence of air. The vehicle can be used, for example, to rescue a mountain climber stuck on a cliff, to extinguish wild fire, or to observe wild lives in a sanctuary. In yet another example, the vehicle provided with the present device can be used in a storm, for example, to land on water for rescuing people.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A flying device comprising:
a disk having a first circular plane with a first predetermined thickness, the disk being configured to rotate around an axis perpendicular to and at a center of the first circular plane;
a ring having a region of a second circular plane bound by two concentric radii with a second predetermined thickness;
a plurality of loads coupled to the disk and the ring;
a plurality of first pivots, each first pivot having one end portion attached to a peripheral region of the disk and the other end portion rotatably attached to a first location of one of the plurality of loads, the plurality of first pivots being circularly arranged in the peripheral region of the disk with a predetermined spacing and respectively coupled to the plurality of loads; and
a plurality of second pivots, each second pivot having one end portion attached to the ring and the other end portion rotatably attached to a second location of one of the plurality of loads, the plurality of second pivots being circularly arranged in the ring with a spacing corresponding to the predetermined spacing and respectively coupled to the plurality of loads;
wherein
the ring is configured to be positioned in parallel with the disk with a shift relative to the disk by an amount substantially equal to a distance between the first location and the second location,
and wherein
the rotation of the disk generates a centrifugal force biased in a direction of the shift based on the ring that follows the rotation of the disk through the plurality of loads, providing the flying device with a force to move toward a direction determined by the shift.

2. The flying device of claim 1, further comprising:
a positioning unit that positions the ring with respect to the disk to adjust the direction of the shift to adjust the direction of biasing the centrifugal force.

3. The flying device of claim 1, further comprising:
a driving shaft attached to the disk, perpendicular to and at the center of the disk to provide torque to rotate the disk around the axis.

4. The flying device of claim 1, wherein
the plurality of first pivots, the plurality of loads and the plurality of second pivots are configured to adjust the distance between the first location and the second location.

5. A flying vehicle provided with two or more flying devices of claim 1, wherein
the flying vehicle is configured to carry at least a driver, systems and materials.

6. The flying vehicle of claim 5, wherein
the systems include one or more of a battery, an engine and a solar cell as a power source for driving the rotation.

7. The flying vehicle of claim 5, wherein
the flying vehicle includes a cover to encase at least air, a driver, systems and materials for outer space traveling.

8. The flying vehicle of claim 5, wherein
the ring is configured to be positioned with respect to the disk in each of the two or more flying devices to generate the biased centrifugal force for steering the flying vehicle.

9. A method of using the flying vehicle of claim 5, comprising:
rotating the disks of at least two of the two or more flying devices to each generate the centrifugal force biased in the direction of the shift of the ring with respect to the disk;
adjusting the direction of the shift of the ring with respect to the disk in each of the at least two flying devices to steer the flying vehicle.

10. The method of claim 9, wherein
the adjusting the direction includes adjusting the direction to steer the flying vehicle to a location where it is difficult to maneuver an aircraft or a helicopter.
